(19) United States
(12) Patent Application Publication
(10) Pub. No.: US 2015/0371600 A1
(43) Pub. Date: Dec. 24, 2015

(54) TIMING CONTROL METHOD, TIME SCHEDULE CONTROLLER AND DISPLAY DEVICE

(71) Applicants: BOE Technology Group Co., Ltd., Beijing (CN); Beijing BOE Display Technology Co., Ltd., Beijing (CN)

(72) Inventor: Zhi Zhang, Beijing (CN)

(21) Appl. No.: 14/469,960

(22) Filed: Aug. 27, 2014

(30) Foreign Application Priority Data
Jun. 19, 2014 (CN) 201410276952.6

(51) Int. Cl. G09G 3/36; G09G 3/32; G09G 3/20

(52) U.S. Cl. CPC G09G 3/3696; G09G 3/2096; G09G 3/3233; G09G 2320/103; G09G 2330/021; G09G 2310/08

(57) ABSTRACT

The present invention provides a timing control method, a timing controller and a display device. The timing control method comprises: determining whether an image content of a current frame is identical to an image data of a previous frame; and stopping, when it is determined that the image content of the current frame is identical to the image data of the previous frame, inputting any data signal to a source driver of a display panel and controlling a thin film transistor in the display panel to be in an off state. According to the present invention, both the power consumption required for the timing controller to output data signals and the power consumption required for the source driver to output data voltages can be saved, such that the power consumption of the display panel can be reduced.

### TECHNICAL FIELD

The present invention relates to display technology, and more particularly, to a timing control method, a time schedule controller and a display device.

### BACKGROUND

A conventional Liquid Crystal Display (LCD) panel typically includes a time schedule controller (TCON), a source driver and a gate driver. The main function of TCON is to process each frame of image data and generate a data signal and a control signal associated with each frame of image data. The control signal contains an output enabling signal, OE1, for controlling the gate driver to output a gate signal. When the output enabling signal OE1 is at high level, the gate signal is at low level; whereas when the output enabling signal OE1 is at low level, the gate signal is at high level. When the data signal is transmitted to the source driver, the source driver converts the received data signal into a data voltage for writing into a corresponding pixel on the LCD panel. In particular, when the gate signal output from the gate driver is received by a gate scan line in the LCD panel, the source driver charges/discharges a pixel corresponding to the gate scan line in the LCD panel in accordance with the corresponding data voltage, thereby displaying a picture.

Conventionally, in order to display picture/image contents, the display panel needs to process each frame of picture as above. Even if the display panel is to display static pictures, the same process has to be repeated multiple times for multiple frames of pictures having the same content, resulted in a high power consumption of the display panel.

### SUMMARY

### Problem to be Solved

The problem to be solved by the present invention is to provide a timing control method, a time schedule controller and a display device, capable of reducing power consumption of a display panel.

### Solutions to the Problem

In order to solve the above problem, a timing control method is provided. The method comprises: determining whether an image content of a current frame is identical to an image data of a previous frame; and stopping, when it is determined that the image content of the current frame is identical to the image data of the previous frame, inputting any data signal to a source driver of a display panel and controlling a thin film transistor in the display panel to be in an off state.

Further, the method comprises: inputting, when it is determined that the image content of the current frame is not identical to the image data of the previous frame, a data signal to the source driver based on the image data of the current frame and inputting a control signal to a gate driver of the display panel.

Further, the method comprises: assigning an initial value for a counter value M and incrementing the counter value M by 1 when it is determined that the image content of the current frame is identical to the image data of the previous frame; determining whether the counter value M is currently smaller than a predetermined value N, where N≧2; stopping, when it is determined that the counter value M is currently smaller than the predetermined value N, inputting any data signal to the source driver of a display panel and controlling the thin film transistor in the display panel to be in an off state; and inputting, when it is determined that the counter value M is currently larger than or equal to the predetermined value N, a data signal to the source driver based on the image data of the current frame, inputting a control signal to a gate driver of the display panel and resetting the counter value M.

In order to solve the above problem, a time schedule controller is provided. The time schedule controller comprises: an image data determining module configured to determine whether an image content of a current frame is identical to an image data of a previous frame; and an output control module configured to control the time schedule controller to stop, when it is determined that the image content of the current frame is identical to the image data of the previous frame, inputting any data signal to a source driver of a display panel and control a thin film transistor in the display panel to be in an off state.

Further, the output control module is configured to control the time schedule controller to input, when it is determined that the image content of the current frame is not identical to the image data of the previous frame, a data signal to the source driver based on the image data of the current frame and input a control signal to a gate driver of the display panel.

Further, the output control module comprises: a counting unit configured to assign an initial value for a counter value M and increment the counter value M by 1 when it is determined that the image content of the current frame is identical to the image data of the previous frame; a determining unit configured to determine whether the counter value M is currently smaller than a predetermined value N, where N≧2; a control unit configured to control the time schedule controller to: stop, when it is determined that the counter value M is currently smaller than the predetermined value N, inputting any data signal to the source driver of a display panel and control the thin film transistor in the display panel to be in an off state; and input, when it is determined that the counter value M is currently larger than or equal to the predetermined value N, a data signal to the source driver based on the image data of the current frame, input a control signal to a gate driver of the display panel and control the counting unit to reset the counter value M.

In order to solve the above problem, a display device is provided. The display device comprises any of the above time schedule controllers.

### Advantageous Effects

According to the present invention, when the display panel is to display static pictures, the pictures can be displayed by stopping inputting any data signal to the source driver of the display panel and controlling the thin film transistor in the display panel to be in an off state. In this way, both the power consumption required for the time schedule controller to output data signals and the power consumption required for the source driver to output data voltages can be saved, such that the power consumption of the display panel can be reduced.

### BRIEF DESCRIPTION OF THE DRAWINGS

FIG. 1 is a flowchart illustrating a timing control method according to an embodiment of the present invention;

FIG. 2 is a flowchart illustrating another timing control method according to an embodiment of the present invention;

FIG. 3 is a schematic diagram showing a time schedule controller according to an embodiment of the present invention;

FIG. 4 is a schematic diagram showing another time schedule controller according to an embodiment of the present invention; and

FIG. 5 is a schematic diagram showing a signal flow in a time schedule controller according to an embodiment of the present invention.

### DETAILED DESCRIPTION OF THE EMBODIMENTS

In the following, the embodiments of the present invention will be described in further detail with reference to the figures. The following embodiments are provided for explaining the present invention, rather than limiting the scope thereof. Obviously, the embodiments described below are only some, rather than all, of the embodiments. Starting from the embodiments of the present invention, those skilled in the art can obtain other embodiments with applying any inventive skills. All these embodiments are to be encompassed by the scope of the present invention.

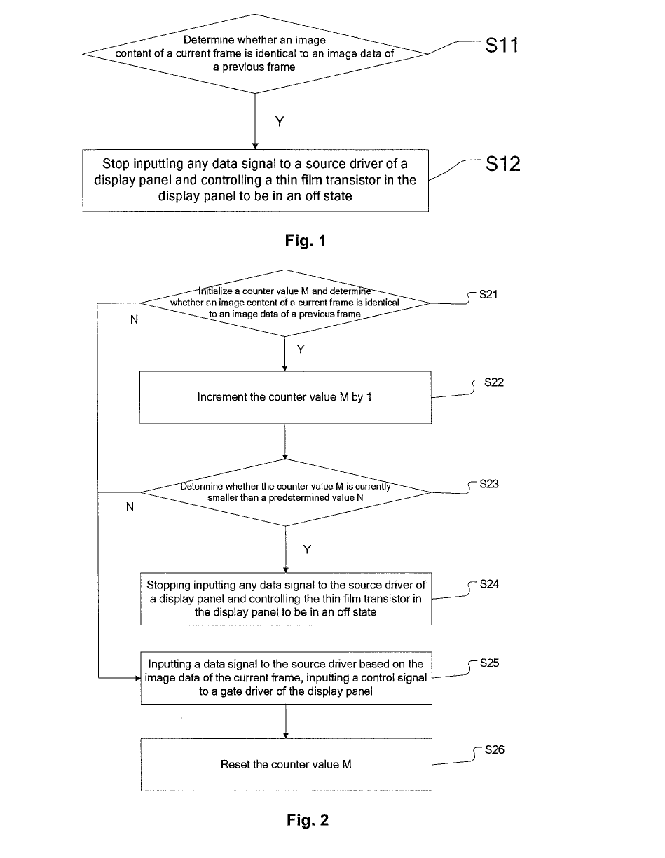

FIG. 1 is a flowchart illustrating a timing control method according to an embodiment of the present invention. The timing control method includes the following steps.

At step S11, it is determined whether an image content of a current frame is identical to an image data of a previous frame. If so, the method proceeds with step S12.

At step S12, any data signal is stopped to be inputted to a source driver of a display panel and a thin film transistor in the display panel is controlled to be in an off state.

In particular, when the time schedule controller (TCON) determines that the image content of the current frame is identical to the image data of the previous frame, it stops inputting any data signal to the source driver of the display panel and maintains an output enabling signal (OE1) in its output control signal at high level. In this case, the source driver cannot receive any data signal from the time schedule controller (TCON) and thus has no output. Further, since the output enabling signal (OE1) received by the gate driver is at high level, the gate signal output from the gate driver to a gate line in the display panel is at low level, such that the thin film transistor (TFT) associated with a pixel in the display panel is in the off state. At this time, due to the presence of a storage capacitor in the pixel, the display panel can continue displaying a picture identical to the picture of the previous frame.

With the timing control method according to the embodiment of the present invention, when the display panel is to display static pictures, the pictures can be displayed by stopping inputting any data signal to the source driver of the display panel and controlling the thin film transistor in the display panel to be in an off state. In this way, both the power consumption required for the time schedule controller to output data signals and the power consumption required for the source driver to output data voltages can be saved, such that the power consumption of the display panel can be reduced.

Preferably, in the above embodiment, when it is determined that the image content of the current frame is not identical to the image data of the previous frame, a data signal is inputted to the source driver based on the image data of the current frame and a control signal is inputted to a gate driver of the display panel.

Further, since the thin film transistor (TFT) in the display panel has a certain leakage current in the off state, the duration in which the storage capacitor in the display panel can maintain the displayed picture is limited. Hence, in the above embodiment, the quality of the picture displayed on the display panel degrades over time as the static picture continues. In order to solve this problem, another timing control method is provided according to an embodiment of the present invention. As shown in FIG. 2, the method includes the following steps.

At step S21, an initial value, e.g., 0, is assigned for a counter value M and it is determined whether an image content of a current frame is identical to an image data of a previous frame. If so, the method proceeds with step S22; otherwise it proceeds with step S25.

At step S22, the counter value M is incremented by 1. Since the time interval between two adjacent frames of pictures is typically a constant value, the counter value M can reflect the time length since the last time a data signal was inputted to the source driver.

At step S23, it is determined whether the counter value M is currently smaller than a predetermined value N, where N≧2. When it is determined that the counter value M is currently smaller than the predetermined value N, the method proceeds with step S24. When it is determined that the counter value M is currently larger than or equal to the predetermined value N, the method proceeds with step S25. Here, the predetermined value N can be 3, 5 or 6.

At step S24, any data signal is stopped to be inputted to the source driver of a display panel and the thin film transistor in the display panel is controlled to be in an off state.

At step S25, a data signal is inputted to the source driver based on the image data of the current frame and a control signal is inputted to a gate driver of the display panel. Then the method proceeds with step S26.

At step S26, the counter value M is reset.

With the timing control method according to the embodiment of the present invention, when the image content of the current frame is identical to the image data of the previous frame, it is determined that the display panel is to display static pictures. Any data signal is stopped to be inputted to the source driver of the display panel and the thin film transistor in the display panel is controlled to be in the off state, such that the image data of the current frame displayed on the display panel can be kept to be the same as the image data of the previous frame without any data signal input to the source driver. Thus, the power consumption of the display panel can be reduced. In addition, when it is determined that a number of consecutive frames of images remain unchanged on the display panel, a data signal is inputted to the source driver and a control signal is inputted to the gate driver timely, so as to update the picture displayed on the display panel. In this way, the quality of the picture displayed on the display panel can be guaranteed.

Reference is now made to FIG. 3, which is a schematic diagram showing a time schedule controller according to an embodiment of the present invention. The time schedule controller includes the following modules.

An image data determining module 31 is configured to determine whether an image content of a current frame is identical to an image data of a previous frame.

An output control module 32 is configured to stop, when it is determined that the image content of the current frame is identical to the image data of the previous frame, inputting any data signal to a source driver of a display panel and control a thin film transistor in the display panel to be in an off state.

In the above time schedule controller, the output control module 32 is further configured to input, when it is determined that the image content of the current frame is not identical to the image data of the previous frame, a data signal to the source driver based on the image data of the current frame and input a control signal to a gate driver of the display panel.

Reference is now made to FIG. 4, which is a schematic diagram showing another time schedule controller according to an embodiment of the present invention. The time schedule controller includes an image data determining module 41 and an output control module 42.

The image data determining module 41 is configured to determine whether an image content of a current frame is identical to an image data of a previous frame.

The output control module 42 includes a counting unit 421, a determining unit 422 and a control unit 423.

The counting unit 421 is configured to assign an initial value, e.g., 0, for a counter value M and increment the counter value M by 1 when it is determined that the image content of the current frame is identical to the image data of the previous frame. Since the time interval between two adjacent frames of pictures is typically a constant value, the counter value M can reflect the time length since the last time a data signal was inputted to the source driver.

The determining unit 422 is configured to determine whether the counter value M is currently smaller than a predetermined value N, where

The control unit 423 is configured to control the time schedule controller to stop, when it is determined that the counter value M is currently smaller than the predetermined value N, inputting any data signal to the source driver of a display panel and control the thin film transistor in the display panel to be in an off state.

The control unit 423 is further configured to input, when it is determined that the counter value M is currently larger than or equal to the predetermined value N, a data signal to the source driver based on the image data of the current frame, input a control signal to a gate driver of the display panel and control the counting unit 421 to reset the counter value M.

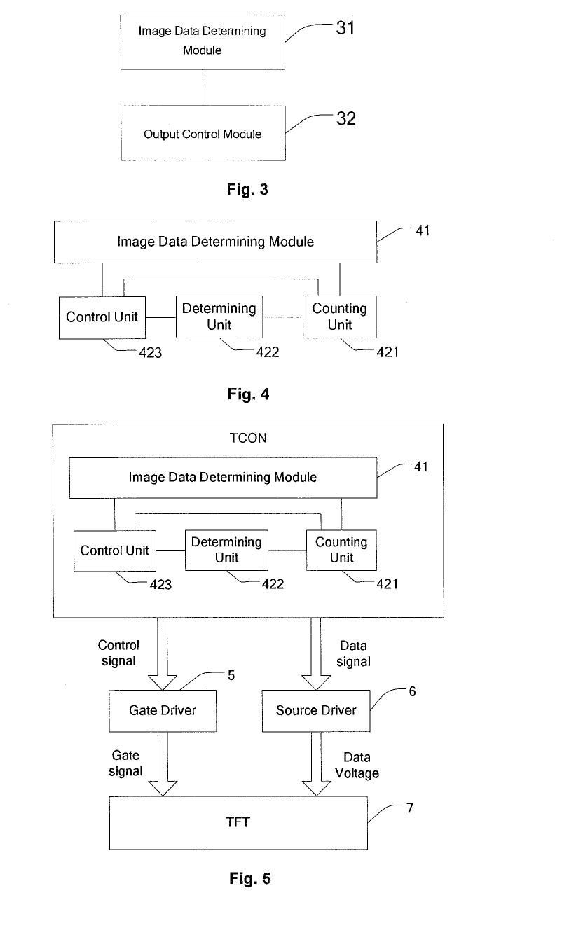

In particular, referring to FIG. 5, when the image data determining module 41 determines that the image content of the current frame is identical to the image data of the previous frame, the counting unit 421 increments the counter value M by 1 and then the determining unit 422 determines whether the counter value M is currently smaller than the predetermined value N. If so, the time schedule controller is controlled to stop inputting any data signal to the source driver 6 of the display panel and maintain an output enabling signal (OE1) in its output control signal at high level. As a result, the gate signal output from the gate driver 5 to a gate line in the display panel is at low level, such that the thin film transistor (TFT) 7 associated with a pixel in the display panel is in the off state. At this time, due to the presence of a storage capacitor in the pixel, the display panel can continue displaying a picture identical to the picture of the previous frame. With the above process, when the display panel is to display static pictures, both the power consumption required for the time schedule controller to output data signals and the power consumption required for the source driver to output data voltages can be saved, such that the power consumption of the display panel can be reduced. In addition, when it is determined that a number of consecutive frames of images remain unchanged on the display panel, i.e., when the determining unit 422 determines that the counter value M is currently larger than or equal to the predetermined value N, a data signal is inputted to the source driver and a control signal is inputted to the gate driver timely, so as to update the picture displayed on the display panel. In this way, the quality of the picture displayed on the display panel can be guaranteed.

Additionally, according to an embodiment of the present invention, a display device including the above time schedule controller is also provided. Here, the display device can be a display screen of a notebook computer, an e-paper, an organic light emitting diode (OLED) display, a liquid crystal display (LCD), a LCD TV, a digital frame, a mobile phone, a tablet computer or any product or component having a display function.

While the embodiments of the present invention have been described above, the scope of the present invention is not limited to these embodiments. Those skilled in the art can make further modifications and changes to these embodiments without departing from the scope of the present invention. These modifications and changes are to be encompassed by the scope of the present invention. Therefore, the scope of the present invention is defined only by the claims as attached.

What is claimed is:

1. A timing control method, comprising:
determining whether an image content of a current frame is identical to an image data of a previous frame; and
stopping, when it is determined that the image content of the current frame is identical to the image data of the previous frame, inputting any data signal to a source driver of a display panel and controlling a thin film transistor in the display panel to be in an off state.

2. The method of claim 1, further comprising:
inputting, when it is determined that the image content of the current frame is not identical to the image data of the previous frame, a data signal to the source driver based on the image data of the current frame and inputting a control signal to a gate driver of the display panel.

3. The method of claim 1, further comprising:
assigning an initial value for a counter value M and incrementing the counter value M by 1 when it is determined that the image content of the current frame is identical to the image data of the previous frame;
determining whether the counter value M is currently smaller than a predetermined value N, where N≧2;
stopping, when it is determined that the counter value M is currently smaller than the predetermined value N, inputting any data signal to the source driver of a display panel and controlling the thin film transistor in the display panel to be in an off state; and
inputting, when it is determined that the counter value M is currently larger than or equal to the predetermined value N, a data signal to the source driver based on the image data of the current frame, inputting a control signal to a gate driver of the display panel and resetting the counter value M.

4. A time schedule controller, comprising:
an image data determining module configured to determine whether an image content of a current frame is identical to an image data of a previous frame; and
an output control module configured to control the time schedule controller to stop, when it is determined that the image content of the current frame is identical to the image data of the previous frame, inputting any data signal to a source driver of a display panel and control a thin film transistor in the display panel to be in an off state.

5. The time schedule controller of claim 4, wherein the output control module is further configured to control the time schedule controller to input, when it is determined that the image content of the current frame is not identical to the image data of the previous frame, a data signal to the source driver based on the image data of the current frame and input a control signal to a gate driver of the display panel.

6. The time schedule controller of claim 4, wherein the output control module comprises:
a counting unit configured to assign an initial value for a counter value M and increment the counter value M by 1 when it is determined that the image content of the current frame is identical to the image data of the previous frame;
a determining unit configured to determine whether the counter value M is currently smaller than a predetermined value N, where N≧2;
a control unit configured to:
control the time schedule controller to stop, when it is determined that the counter value M is currently smaller than the predetermined value N, inputting any data signal to the source driver of a display panel and control the thin film transistor in the display panel to be in an off state; and
input, when it is determined that the counter value M is currently larger than or equal to the predetermined value N, a data signal to the source driver based on the image data of the current frame, input a control signal to a gate driver of the display panel and control the counting unit to reset the counter value M.

7. A display device comprising the time schedule controller according to claim 4.

8. A display device comprising the time schedule controller according to claim 5.

9. A display device comprising the time schedule controller according to of claim 6.
